(19) United States
(12) Patent Application Publication
(10) Pub. No.: US 2015/0163439 A1
(43) Pub. Date: Jun. 11, 2015

(54) SOLID-STATE IMAGING DEVICE

(71) Applicant: Kabushiki Kaisha Toshiba, Minato-ku (JP)

(72) Inventor: You YOSHIOKA, Taito (JP)

(73) Assignee: Kabushiki Kaisha Toshiba, Minato-ku (JP)

(21) Appl. No.: 14/475,839

(22) Filed: Sep. 3, 2014

(30) Foreign Application Priority Data
Dec. 5, 2013 (JP) 2013-252109

(51) Int. Cl. H04N 5/3745; H04N 5/378; H01L 27/146

(52) U.S. Cl. CPC H04N 5/3745; H01L 27/14609; H04N 5/378

(57) ABSTRACT

According to one embodiment, in a solid-state imaging device, a control unit has each of a plurality of pixels execute a unit operation a plurality of times during a frame period without outputting a signal based on a voltage of the charge-to-voltage converter via an amplifying unit. The unit operation includes a reset operation, a charge storage operation, and a transfer operation. The reset operation resets a photoelectric conversion unit while keeping a transfer unit in non-active state. The charge storage operation releases reset of the photoelectric conversion unit to have the photoelectric conversion unit store charges while keeping the transfer unit in the non-active state. The transfer operation transfers charge in the photoelectric conversion unit to the charge-to-voltage converter by keeping the transfer unit in active state.

### CROSS-REFERENCE TO RELATED APPLICATIONS

This application is based upon and claims the benefit of priority from Japanese Patent Application No. 2013-252109, filed on Dec. 5, 2013; the entire contents of which are incorporated herein by reference.

### FIELD

Embodiments described herein relate generally to a solid-state imaging device.

### BACKGROUND

Because objects such as LED traffic lights and LED destination indicators of trains light up pulsedly (blink), there are periods during which they are blacked out, and thus it may be difficult to obtain an image of the object in a lit-up state when picking up an image of the object with a solid-state imaging device. Hence, a technique for easily obtaining an image of the blinking object in a lit-up state is desired.

### BRIEF DESCRIPTION OF THE DRAWINGS

FIG. 1 is a diagram showing the configuration of an imaging system to which a solid-state imaging device according to an embodiment is applied;

FIG. 2 is a diagram showing the configuration of the imaging system to which the solid-state imaging device according to the embodiment is applied;

FIG. 3 is a diagram showing the configuration of the solid-state imaging device according to the embodiment;

FIG. 4 is a diagram showing the configuration of the solid-state imaging device according to the embodiment;

FIG. 5 is a diagram showing the configuration of a pixel in the embodiment;

FIG. 6 is a chart showing the operation of the solid-state imaging device according to the embodiment;

FIG. 7 is a chart showing the operation of the pixel in the embodiment;

FIGS. 8A to 8C are diagrams showing charge storage periods and storage stop periods in the embodiment and modified examples thereof;

FIGS. 9A and 9B are diagrams showing charge storage periods and storage stop periods in modified examples of the embodiment; and

FIGS. 10A and 10B are charts showing the operation of a pixel in modified examples of the embodiment.

### DETAILED DESCRIPTION

In general, according to one embodiment, there is provided a solid-state imaging device including a plurality of pixels and a control unit. The plurality of pixels are arranged. The control unit controls the plurality of pixels. Each of the plurality of pixels has a photoelectric conversion unit, a charge-to-voltage converter, a transfer unit, and an amplifying unit. The transfer unit, when in an active state, transfers charges in the photoelectric conversion unit to the charge-to-voltage converter and, when in a non-active state, does not transfer charges in the photoelectric conversion unit to the charge-to-voltage converter. The amplifying unit outputs a signal based on the voltage of the charge-to-voltage converter. The control unit has each of the plurality of pixels execute a unit operation a plurality of times during a frame period without outputting the signal based on the voltage of the charge-to-voltage converter via the amplifying unit. The unit operation includes a reset operation, a charge storage operation, and a transfer operation. The reset operation resets the photoelectric conversion unit while keeping the transfer unit in the non-active state. The charge storage operation releases the reset of the photoelectric conversion unit to have the photoelectric conversion unit store charges while keeping the transfer unit in the non-active state. The transfer operation transfers charges in the photoelectric conversion unit to the charge-to-voltage converter by keeping the transfer unit in the active state.

Exemplary embodiments of a solid-state imaging device will be explained below in detail with reference to the accompanying drawings. The present invention is not limited to the following embodiments.

### Embodiment

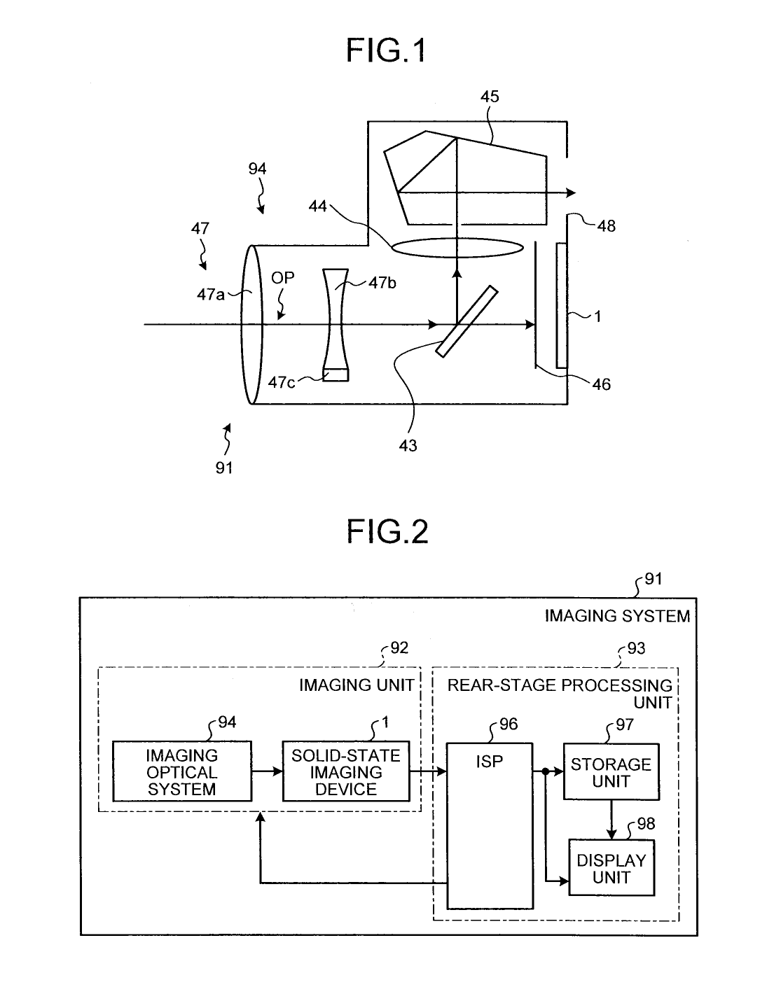

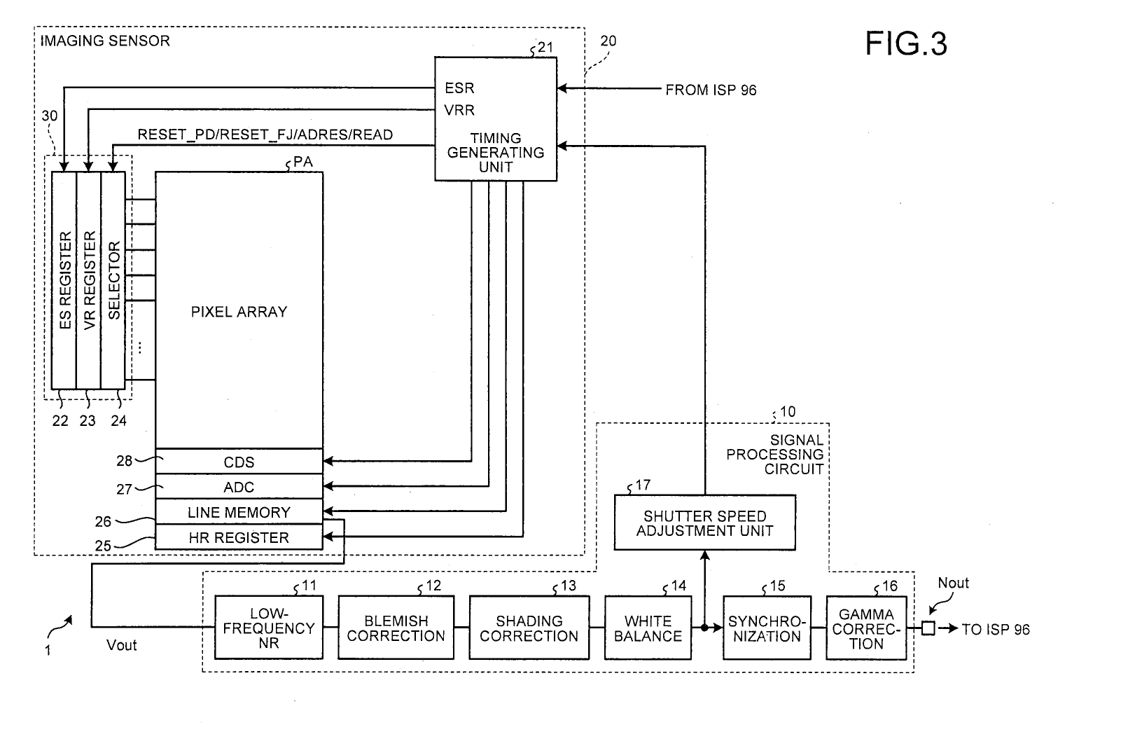

The solid-state imaging device 1 according to the embodiment will be described. The solid-state imaging device 1 is applied to, e.g., an imaging system 91 shown in FIGS. 1 and 2. FIGS. 1 and 2 are diagrams showing schematically the configuration of the imaging system 91. The imaging system 91 may be, for example, a digital camera, a digital video camera, or the like, or a camera module incorporated in an electronic device (e.g., a mobile terminal with a camera). Or the imaging system 91 may be, for example, a vehicle-mounted drive recorder. The imaging system 91 comprises an imaging unit 92 and a rear-stage processing unit 93 as shown in FIG. 2. The imaging unit 92 is, for example, a camera module. The imaging unit 92 has an imaging optical system 94 and the solid-state imaging device 1. The rear-stage processing unit 93 has an ISP (Image Signal Processor) 96, a storage unit 97, and a display unit 98.

The imaging optical system 94 has an imaging lens 47, a half mirror 43, a mechanical shutter 46, a lens 44, a prism 45, and a finder 48. The imaging lens 47 has pickup lenses 47a, 47b, and a lens drive mechanism 47c. The imaging optical system 94 does not have a diaphragm. The lens drive mechanism 47c can drive the pickup lens 47b along an optical axis OP. Although FIG. 1 shows illustratively the case where the imaging lens 47 has two pickup lenses 47a, 47b, the imaging lens 47 may have multiple pickup lenses.

The solid-state imaging device 1 is placed at a predicted imaging plane of the imaging lens 47. For example, the imaging lens 47 refracts incident light to lead via the half mirror 43 and the mechanical shutter 46 to the imaging plane of the solid-state imaging device 1 so as to form an image of an object on the imaging plane (pixel array PA) of the solid-state imaging device 1. The solid-state imaging device 1 generates an image signal according to the object image.

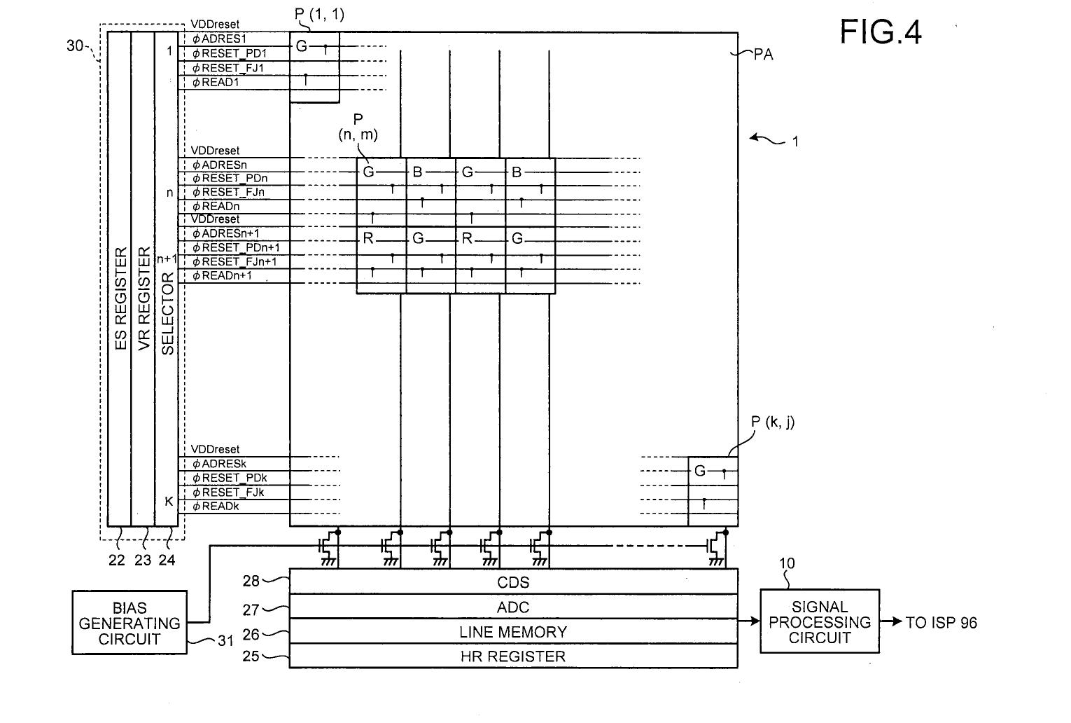

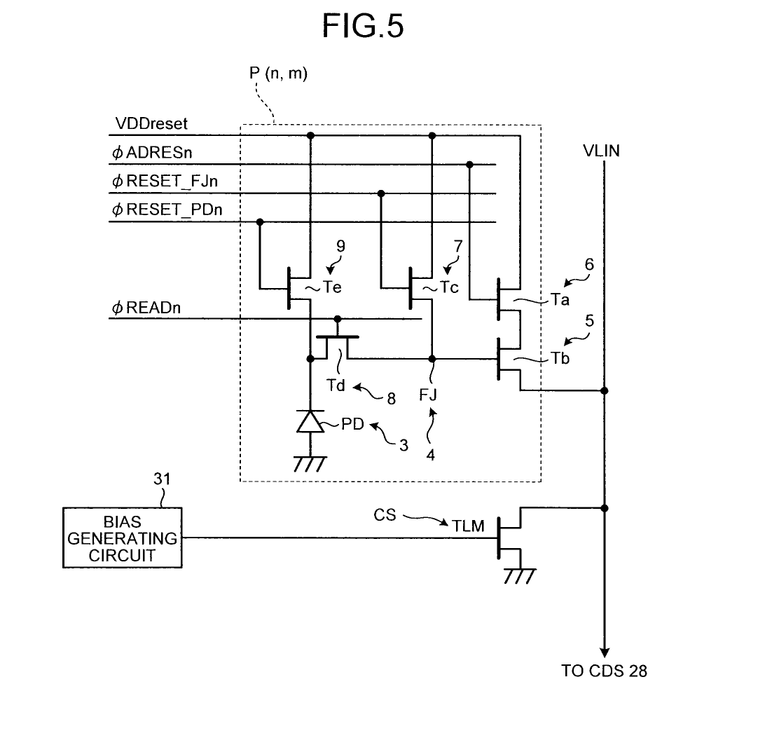

The solid-state imaging device 1 has an imaging sensor 20 and a signal processing circuit 10 as shown in FIGS. 3 and 4. FIGS. 3 and 4 are diagrams showing the circuit configuration of the solid-state imaging device 1. The imaging sensor 20 may be, for example, a CMOS image sensor or a CCD image sensor. The imaging sensor 20 has a pixel array PA, a timing generating unit 21, a control unit 30, a correlated double sampling unit (CDS circuit) 28, an analog-to-digital converter (ADC circuit) 27, a line memory 26, and a horizontal shift register (HR register) 25.

The pixel array PA has a plurality of pixels P(l, 1) to P(k, J) arranged two-dimensionally as shown in FIG. 4. The pixel array PA has pixels P(l, 1) to P(k, J) arranged in k rows by J columns, for example. The control unit 30 controls the pixel array PA, e.g., on a row basis according to control signals from the timing generating unit 21.

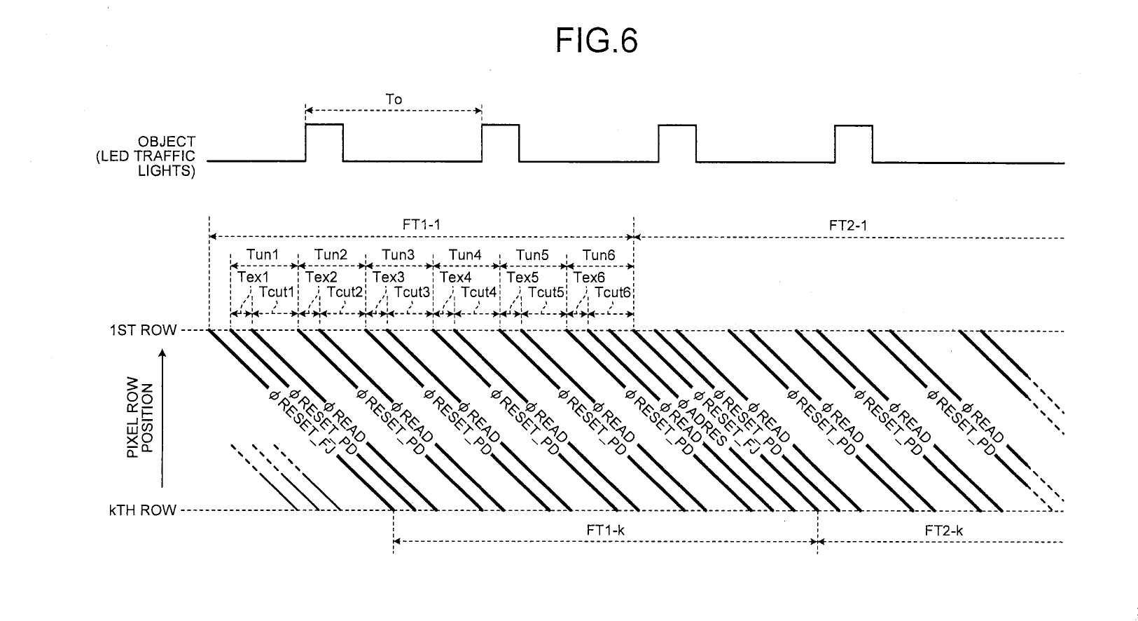

Each pixel P has a photoelectric conversion unit 3, a transfer unit 8, a charge-to-voltage converter 4, a first reset unit 9, a second reset unit 7, an amplifying unit 5, and a selector 6 as shown in FIG. 5. FIG. 5 is a diagram showing the configuration of each pixel P. FIG. 5 shows illustratively pixel P(n, m) in the n^{th} row and m^{th} column, and the other pixels also have similar configuration.

The photoelectric conversion unit 3 performs photoelectric conversion to generate and store an amount of charges according to received light. The photoelectric conversion unit 3 has, for example, a photodiode PD.

When in an active state, the transfer unit 8 transfers charges in the photoelectric conversion unit 3 to the charge-to-voltage converter 4 and when in a non-active state, does not transfer charges in the photoelectric conversion unit 3 to the charge-to-voltage converter 4. When receiving a control signal φREADn of an active level from the control unit 30, the transfer unit 8 transfers charges in the photoelectric conversion unit 3 to the charge-to-voltage converter 4. When receiving the control signal φREADn of a non-active level from the control unit 30, the transfer unit 8 does not transfer charges in the photoelectric conversion unit 3 to the charge-to-voltage converter 4. The transfer unit 8 has, e.g., a transfer transistor Td functioning as a transfer gate and, when receiving the control signal φREADn of an active level at its gate, turns on to transfer charges in the photoelectric conversion unit 3 to the charge-to-voltage converter 4 and, when receiving the control signal φREADn of a non-active level at its gate, turns off not to transfer charges in the photoelectric conversion unit 3 to the charge-to-voltage converter 4.

The charge-to-voltage converter 4 converts the transferred charges to a voltage with use of its parasitic capacitance. The charge-to-voltage converter 4 has, e.g., a floating junction FJ.

When receiving a control signal φRESET_PDn of the active level from the control unit 30, the first reset unit 9 resets the potential of the photoelectric conversion unit 3 to a predetermined potential (e.g., VDDreset). For example, while the transfer unit 8 is kept in a non-active state, the first reset unit 9 resets the potential of the photoelectric conversion unit 3 to a predetermined potential (e.g., VDDreset). The first reset unit 9 has, e.g., a reset transistor Te and, when receiving the control signal φRESET_PDn of the active level at its gate, turns on to reset the potential of the photoelectric conversion unit 3 to a predetermined potential (e.g., VDDreset).

Then, the photoelectric conversion unit 3 starts storing charges after the reset by the first reset unit 9 is released and continues storing charges until the charges are transferred by the transfer unit 8 to the charge-to-voltage converter 4. That is, the photoelectric conversion unit 3 performs charge storage operation during a charge storage period from the releasing timing of reset operation by the first reset unit 9 to the start timing of transfer operation by the transfer unit 8.

When receiving a control signal φRESET_FJn of the active level from the control unit 30, the second reset unit 7 resets the potential of the charge-to-voltage converter 4 to a predetermined potential (e.g., VDDreset). The second reset unit 7 has, e.g., a reset transistor Tc and, when receiving the control signal φRESET_FJn of the active level at its gate, turns on to reset the potential of the charge-to-voltage converter 4 to a predetermined potential (e.g., VDDreset).

When pixel P(n, m) goes into a selected state, the amplifying unit 5 outputs a signal based on the voltage of the charge-to-voltage converter 4 onto a signal line VLIN. The amplifying unit 5 has, e.g., an amp transistor Tb and, when pixel P(n, m) goes into a selected state, together with a load current source CS connected via the signal line VLIN, performs source follower operation, thereby outputting a signal according to the voltage of the charge-to-voltage converter 4 onto the signal line VLIN. The load current source CS has a load transistor TLM and a bias generating circuit 31.

When receiving a control signal φADRESn of the active level from the control unit 30, the selector 6 puts pixel P(n, m) in the selected state and, when receiving the control signal φADRESn of the non-active level from the control unit 30, puts pixel P(n, m) in the non-selected state. The selector 6 has, e.g., a select transistor Ta and, when receiving the control signal φDRESn of the active level at its gate, turns on to put pixel P(n, m) in the selected state and, when receiving the control signal φADRESn of the non-active level at its gate, turns off to put pixel P(n, m) in the non-selected state. Note that pixel P may be configured with the selector 6 omitted. In that case, the second reset unit 7 may operate to put pixel P in the selected state/non-selected state. For example, the second reset unit 7 may reset the potential of the charge-to-voltage converter 4 to a first potential (e.g., VDD level), thereby putting pixel P in the selected state and reset the potential of the charge-to-voltage converter 4 to a second potential (such a potential that the amplifying unit 5 (amp transistor Tb) turns off, e.g., GND level), thereby putting pixel P in the non-selected state.

Although not shown, a color filter to selectively lead light in a specific wavelength range out of incident light from the imaging optical system 94 to the photoelectric conversion unit 3 may be provided for each pixel P. In this case, color filters for pixels P(1, 1) to P(k, J) may be arranged to form a Bayer array as shown in FIG. 4. In FIG. 4, R, G, B indicate red, green, and blue color filters being provided, respectively.

The timing generating unit 21 shown in FIG. 3 generates control signals to control various timings according to control signals received from the ISP 96 and control signals received from the signal processing circuit 10.

The control unit 30 controls the pixel array PA according to control signals from the timing generating unit 21. The control unit 30 has, e.g., an electronic shutter register (ES register) 22, a vertical shift register (VR register) 23, and a selector 24.

The signal generated in each pixel P is read from the pixel P to the CDS circuit 28 side by the timing generating unit 21, ES register 22, VR register 23, and selector 24 and is converted into a pixel signal (digital signal) through the CDS circuit 28 and the ADC circuit 27 to be held in the line memory 26. The pixel signals (digital signals) Vout of the columns held in the line memory 26 are sequentially selected and outputted by the HR register 25 to the signal processing circuit 10. The signal processing circuit 10 performs signal processing on the signals from the pixels to generate image data.

The signal processing circuit 10 has, for example, a low-frequency noise reduction unit (low-frequency NR unit) 11, a blemish correction unit 12, a shading correction unit 13, a white balance unit (WB unit) 14, a synchronization unit 15, a gamma correction unit 16, and a shutter speed adjustment unit 17. The low-frequency NR unit 11 receives the pixel signals (digital signals) Vout from the imaging sensor 20 and performs noise cancellation to reduce noise in the pixel signals. The blemish correction unit 12 receives the pixel signals after the noise cancellation and performs blemish correction, which interpolates the signal of a blemish pixel using the signals of pixels in its vicinity. The shading correction unit 13 receives the pixel signals after the blemish correction and performs shading correction to correct reduction in brightness in the periphery of the screen. The WB unit 14 receives the pixel signals after the shading correction and performs white balance adjustment according to the color temperature of the light source. The synchronization unit 15 receives the pixel signals after the white balance adjustment and generates R, G, and B signals for each pixel by interpolation (demosaic) of the digital image signal. The gamma correction unit 16 receives the generated R, G, and B signals and performs gamma correction to correct the shades of an image and outputs pixel signals after the gamma correction as image data. The signal processing circuit 10 outputs the image data to the ISP 96 via an output node Nout.

Because the imaging optical system 94 does not have a diaphragm as mentioned above, exposure control to obtain appropriate exposure is performed by adjusting the shutter speed of the electronic shutter by the signal processing circuit 10. For example, the shutter speed adjustment unit 17 receives the pixel signals after the white balance adjustment and obtains the luminance value of each pixel. The shutter speed adjustment unit 17 adds up the obtained luminance value of each pixel over the entire screen and takes the adding-up result as an exposure evaluation value. The shutter speed adjustment unit 17 obtains such a length of the charge storage period (i.e., shutter speed) that the exposure evaluation value becomes close to a target value, during which period the photoelectric conversion unit 3 of each pixel P is to perform charge storage operation. The shutter speed adjustment unit 17 supplies a control signal to specify the obtained length of the charge storage period (shutter speed) to the timing generating unit 21.

According to the control signal specifying the length of the charge storage period (shutter speed), the timing generating unit 21 supplies a control signal to specify the start timing of the charge storage period to the ES register 22. The ES register 22 generates an storage start control signal according to the received control signal to supply to the selector 24. The timing generating unit 21 supplies a control signal to specify the end timing of the charge storage period to the VR register 23 according to the control signal specifying the length of the charge storage period (shutter speed). The VR register 23 generates an storage end control signal according to the received control signal to supply to the selector 24. Further, the timing generating unit 21 supplies timing control signals RESET_PD, RESET_FJ, ADRES, and READ to the selector 24. The selector 24 supplies control signals φRESET_FJ1 to φRESET_FJk to reset the potential of the charge-to-voltage converter 4 to the rows of pixels P in response to the timing control signal RESET_FJ. The selector 24 supplies control signals φRESET_PD1 to φRESET_PDk to have charge storage operation start to the rows of pixels P in response to the storage start control signal and the timing control signal RESET_PD. The selector 24 supplies control signals φREAD1 to φREADk to have charge storage operation end to the rows of pixels P in response to the storage end control signal. The selector 24 supplies control signals φADRES1 to φADRESk to put the pixel in the selected state to output a signal based on the voltage of the charge-to-voltage converter 4 to the rows of pixels P in response to the timing control signal ADRES. By this means, the length of the charge storage period (shutter speed) of pixels P of each row can be controlled so that the exposure evaluation value becomes close to a target value, and thus pixel signals under that control can be obtained.

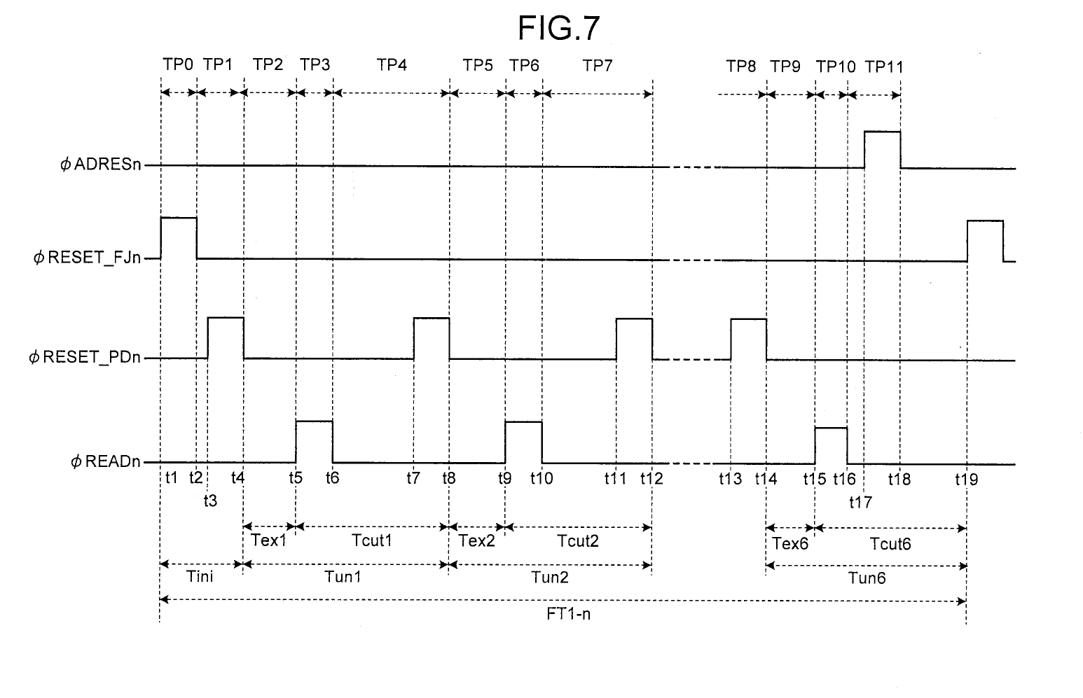

With the solid-state imaging device 1, it is sometimes required to pick up an image of an object such as LED traffic lights or an LED destination indicator of a train. With such objects that light up pulsedly (blink), there are periods during which they are blacked out as shown in FIG. 6, and periods during which they are blacked out tend to be longer than periods during which they are lit up. Thus, when simply picking up an image of the object with the solid-state imaging device 1, there is a possibility that you are not able to obtain an image of the object in a lit-up state.

Further, because objects such as LED traffic lights and LED destination indicators of trains may operate at frequencies different from the commercial power supply, it may be difficult to realize the blinking cycle of the object in advance. If the blinking cycle of the object is unknown, it is difficult to pick up an image of the object while the object is in the lit-up state, that is, to synchronize the charge storage periods of the pixels P with the blinking cycle of the object.

Here, consider the case where in order to obtain an image of the blinking object in the lit-up state, the light-up pulse phase of the object is detected, thereby obtaining the blinking cycle of the object so as to synchronize the charge storage periods of the pixels P with the blinking cycle. In this case, in order to synchronize the charge storage periods of the pixels P with periods during which the object is lit up, the blinking cycle of the object needs to be accurately detected, and thus a complex structure (complex detecting system) needs to be provided in the solid-state imaging device 1. Thus, the production cost of the solid-state imaging device 1 may increase.

Further, in the case where the blinking cycle of the object dynamically changes like an LED destination indicator in which characters flow laterally, it is probable that the blinking cycle of the object cannot be detected even with a complex structure (complex detecting system) provided in the solid-state imaging device 1. In this case, it is difficult to synchronize the charge storage periods of the pixels P with the blinking cycle of the object.

Consider the case where in order to obtain an image of the blinking object in the lit-up state, the charge storage periods of the pixels P are made longer than the blinking cycle of the object (e.g., 1/100 to 1/120 sec). In this case, because the imaging optical system 94 does not have a diaphragm, if the F-number of the imaging optical system 94 is small (lens is bright), then exposure gain (e.g., gain of white balance adjustment) cannot be dropped sufficiently by the signal processing circuit 10 side, and thus it is difficult to obtain appropriate exposure.

Accordingly, the embodiment is aimed at obtaining an image of a blinking object in the lit-up state by executing a unit operation including the reset operation by the first reset unit 9, the charge storage operation by the photoelectric conversion unit 3, and the transfer operation by the transfer unit 8 a number of times during one frame period, in each pixel P of the solid-state imaging device 1, with a simple configuration (without a complex detecting system). One frame period is a period during which to acquire the signal for obtaining an image of one frame in the solid-state imaging device 1.

Specifically, the control unit 30, for each pixel P shown in FIG. 5, in each frame period, resets the charge-to-voltage converter 4 and, after the reset of the charge-to-voltage converter 4 finishes, has the pixel execute the unit operation a plurality of times and, when the plurality of times of the transfer operation finish, output a signal based on the voltage of the charge-to-voltage converter 4 via the amplifying unit 5. The unit operation includes the reset operation, the charge storage operation, and the transfer operation.

In the reset of the charge-to-voltage converter 4 performed prior to the plurality of times of the transfer operation, the charge-to-voltage converter 4 is reset by the second reset unit 7 while keeping the transfer unit 8 in the non-active state. For example, in this reset, the reset transistor Tc is turned on to reset the potential of the floating junction FJ to VDDreset while keeping the transfer transistor Td in an off state. By this means, if charges remain in the floating junction FJ, the remaining charges can be discharged to, e.g., the reset power supply side.

In the reset operation in the unit operation, the photoelectric conversion unit 3 is reset by the first reset unit 9 while keeping the transfer unit 8 in the non-active state. For example, in this reset operation, the reset transistor Te is turned on to reset the potential of the photodiode PD to VDDreset while keeping the transfer transistor Td in the off state. By this means, if charges remain in the photodiode PD, the remaining charges can be discharged to, e.g., the reset power supply side so as to enable the photodiode PD to store charges again. In the charge storage operation in the unit operation, the reset of the photoelectric conversion unit 3 by the first reset unit 9 is released to have the photoelectric conversion unit 3 store charges while keeping the transfer unit 8 in the non-active state. For example, in the charge storage operation, the photodiode PD accumulates an amount of charges according to received light while the transfer transistor Td and the reset transistor Te are kept in the off state.

In the transfer operation in the unit operation, charges in the photoelectric conversion unit 3 is transferred to the charge-to-voltage converter 4 by keeping the transfer unit 8 in the active state. For example, in the transfer operation, charges in the photodiode PD is transferred to the floating junction FJ by keeping the transfer transistor Td in an on state.

In each of the plurality of times of the unit operation, in the charge-to-voltage converter 4 (e.g., floating junction FJ), each time that charges are transferred, the transferred charges are added to charge already held. That is, the charge-to-voltage converter 4 adds the charges each time that charges are transferred during one frame period, thereby performing a plurality of times of charge addition. The number of times of charge addition is less by one than the number of times of the transfer operation.

Then, in the operation of outputting the signal of pixel P when the plurality of times of the transfer operation finish and the plurality of times of charge addition in the charge-to-voltage converter 4 finish, the amplifying unit 5 outputs a signal based on the voltage of the charge-to-voltage converter 4 onto the signal line VLIN while the selector 6 keeps pixel P in the selected state. For example, in the select operation, while keeping the select transistor Ta in the on state so that pixel P is in the selected state, correspondingly the amplifying transistor Tb, together with the load current source CS, performs source follower operation, thereby outputting a signal according to the voltage of the charge-to-voltage converter 4 onto the signal line VLIN.

More specifically, the solid-state imaging device 1 operates as shown in FIG. 6. FIG. 6 is a chart showing the operation of the solid-state imaging device 1.

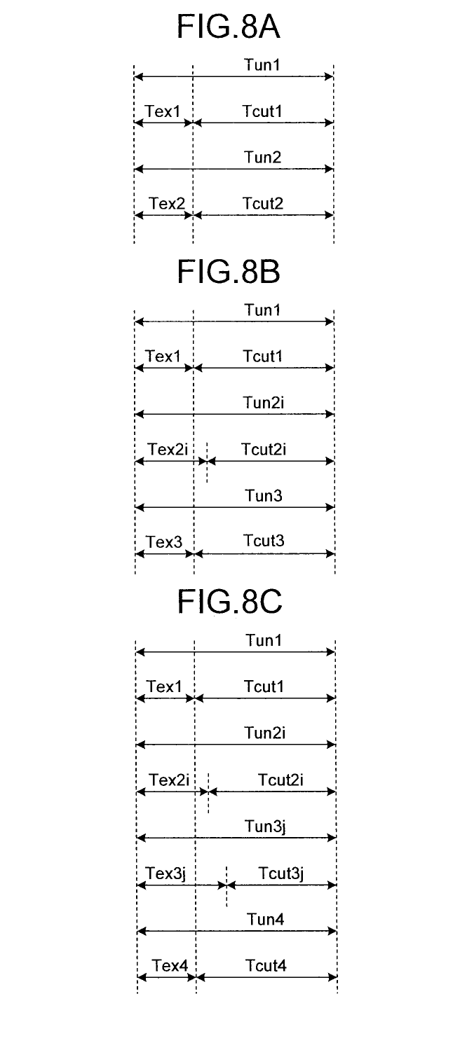

In the solid-state imaging device 1, the control unit 30 scans and controls, e.g., pixels of the first row to pixels of the k^{th} row in the pixel array PA on a row basis. Accordingly, frame periods FT1-1, FT2-1 for the pixels of the first row to frame periods FT1-k, FT2-k for the pixels of the k^{th} row are offset in time one after another. Each frame period is, for example, a period from the reset start timing of the charge-to-voltage converters 4 in the pixels of a row to the next reset start timing of the charge-to-voltage converters 4 (see FIG. 7).

For example, in the pixel array PA, first the control signals φRESET_FJ are generated to be at the active level sequentially for the line (first row) at the top of the screen to the line (k^{th} row) at the bottom before exposure (charge storage operation) during the charge storage periods Tex1 to Tex6. Thus, the potential of the charge-to-voltage converter 4 in each pixel P of each row is reset.

Then the control signals φRESET_PD to have exposure (charge storage operation) start are generated to be at the active level sequentially for the line (first row) at the top of the screen to the line (k^{th} row) at the bottom. In the pixels P of each row, at the timing when the control signal φRESET_PD changes from the active level to the non-active level, charge storage operation by the photoelectric conversion unit 3 starts. That is, at this timing, the charge storage period Tex1 starts.

Next, correspondingly to the finish timing of the charge storage period Tex1, the control signals φREAD are generated to be at the active level sequentially for the line (first row) at the top of the screen to the line (kth row) at the bottom. In the pixels P of each row, at the timing when the control signal φREAD changes from the non-active level to the active level, charge storage operation by the photoelectric conversion unit 3 ends. That is, at this timing, the charge storage period Tex1 finishes.

Subsequently, after a storage stop period Tcut1 elapses, the control signals φRESET_PD to have exposure (charge storage operation) start are again generated to be at the active level sequentially for the line (first row) at the top of the screen to the line (k^{th} row) at the bottom. In the pixels P of each row, again at the timing when the control signal φRESET_PD changes from the active level to the non-active level, charge storage operation by the photoelectric conversion unit 3 starts. That is, at this timing, the charge storage period Tex2 starts.

Then, correspondingly to the finish timing of the charge storage period Tex2, the control signals φREAD are again generated to be at the active level sequentially for the line (first row) at the top of the screen to the line (k^{th} row) at the bottom. In the pixels P of each row, again at the timing when the control signal φREAD changes from the non-active level to the active level, charge storage operation by the photoelectric conversion unit 3 ends. That is, at this timing, the charge storage period Tex2 finishes.

After the scan of the control signals φRESET_PD and the scan of the control signals φREAD are repeated and exposure (charge storage operation) ends with the scan of the last control signal φREAD, the control signals 4ADRES to output signals based on the voltages of the charge-to-voltage converters 4 onto the signal lines VLIN are scanned. That is, the control signals φADRES are generated to be at the active level sequentially for the line (first row) at the top of the screen to the line (k^{th} row) at the bottom. The signals outputted from the pixels P of each row onto the signal lines VLIN are supplied via the CDS circuit 28 to the ADC circuit 27, are A/D converted by the ADC circuit 27, and are supplied via the line memory 26 to the signal processing circuit 10, so that the exposure amounts are read out to the signal processing circuit 10.

As shown in FIG. 6, in order to obtain an image of the lit-up state of an object lighting up pulsedly (blinking) such as an LED electronic display or LED traffic lights, one frame period is made considerably longer than the blinking cycle To of the object. Even where, although it is difficult to obtain an optimum exposure amount because of a diaphragm and an ND filter, it is desired to shorten the exposure time, in the present embodiment, by making the charge storage periods Tex1 to Tex6 shorter than the storage stop periods Tcut1 to Tcut6, appropriate exposure can be obtained. That is, while the time necessary for all exposure operation is a time from an exposure start point (start timing of a frame period) to an exposure end point (end timing of the frame period), the exposure time as the amount of light is the total length of only the charge storage periods Tex1 to Tex6 with the storage stop periods Tcut1 to Tcut6 not contributing to exposure. Thus, an exposure effect is obtained that, while the time for which to respond to the object is long, the exposure time is equivalently short in the total amount of light. Thus, while avoiding over-exposure, an image of the lit-up state of an object lighting up pulsedly (blinking) such as an LED electronic display or LED traffic lights can be easily obtained.

For example, in the case shown in FIG. 6, in the charge storage periods Tex2 and Tex5, an image of an object in the lit-up state can be imaged.

At this time, for example, the timing generating unit 21 shown in FIG. 3 divides the specified charge storage period according to the control signal specifying the length of the charge storage period (shutter speed) into a plurality of charge storage periods. The timing generating unit 21 supplies a control signal to specify the start timing of each charge storage period according to the plurality of divided charge storage periods to the ES register 22. The ES register 22 generates a storage start control signal according to the received control signal to supply to the selector 24. The timing generating unit 21 supplies a control signal to specify the end timing of each charge storage period according to the plurality of divided charge storage periods to the VR register 23. The VR register 23 generates a storage end control signal according to the received control signal to supply to the selector 24. Further, the timing generating unit 21 supplies timing control signals RESET_PD, RESET_FJ, ADRES, and READ to the selector 24. The selector 24 supplies control signals φRESET_PD1 to φRESET_PDk to have charge storage operation start to the rows of pixels P in response to the storage start control signal and the timing control signal RESET_PD. The selector 24 supplies control signals φREAD1 to φREADk to have charge storage operation end to the rows of pixels P in response to the storage end control signal. Thus, the length of the charge storage period (shutter speed) of pixels P of each row can be controlled so that the exposure evaluation value becomes close to a target value.

For example, where the unit operation is executed six times as shown in FIG. 6 (that is, charge storage operation is executed six times), for the required shutter speed Tes and the charge storage periods Tex1 to Tex6 in one frame period, the following equation 1 holds.

Tes=Tex1+Tex2+Tex3+Tex4+Tex5+Tex6 Eq. 1

Next, the operation of each pixel P will be specifically described using FIG. 7. FIG. 7 is a waveform chart showing the operation of pixel P. FIG. 7 shows illustratively the operation of pixel P in the nth row and also applies to the pixels in the other rows.

At timing t1, the control unit 30 changes the control signal φRESET_FJn from the non-active level to the active level. Thus, in pixel P in the n^{th} row (see FIG. 5), the reset transistor Tc is turned on to start resetting the potential of the floating junction FJ to a predetermined potential (e.g., VDDreset). That is, the second reset unit 7 starts resetting the potential of the charge-to-voltage converter 4.

At timing t2, the control unit 30 changes the control signal φRESET_FJn from the active level to the non-active level. Thus, in pixel P in the n^{th} row (see FIG. 5), the reset transistor Tc is turned off to finish resetting the potential of the floating junction FJ. That is, the second reset unit 7 finishes resetting the potential of the charge-to-voltage converter 4.

At timing t3, the control unit 30 changes the control signal φRESET_PDn from the non-active level to the active level. Thus, in pixel P in the n^{th} row (see FIG. 5), the reset transistor Te is turned on to start resetting the potential of the photodiode PD to a predetermined potential (e.g., VDDreset). That is, the first reset unit 9 starts resetting the potential (charges) of the photoelectric conversion unit 3.

At timing t4, the control unit 30 changes the control signal φRESET_PDn from the active level to the non-active level. Thus, in pixel P in the nth row (see FIG. 5), the reset transistor Te is turned off to finish resetting the potential of the photodiode PD. That is, the first reset unit 9 finishes resetting the potential of the photoelectric conversion unit 3, and the photoelectric conversion unit 3 starts charge storage operation.

At timing t5, the control unit 30 changes the control signal φREADn from the non-active level to the active level. Thus, in pixel P in the n^{th} row (see FIG. 5), the transfer transistor Td is turned on to transfer the charges in the photodiode PD to the floating junction FJ. That is, the photoelectric conversion unit 3 ends charge storage operation, and simultaneously the transfer unit 8 starts transfer operation.

At timing t6, the control unit 30 changes the control signal φREADn from the active level to the non-active level. Thus, in pixel P in the n^{th} row (see FIG. 5), the transfer transistor Td is turned off to finish transferring the charges to the floating junction FJ. That is, the transfer unit 8 finishes transfer operation.

At timing t7, the control unit 30 changes the control signal φRESET_PDn from the non-active level to the active level. Thus, in pixel P in the nth row (see FIG. 5), the reset transistor Te is turned on to start resetting the potential of the photodiode PD to the predetermined potential (e.g., VDDreset). That is, the first reset unit 9 starts resetting the potential (charge) of the photoelectric conversion unit 3.

At timing t8, the control unit 30 changes the control signal φRESET_PDn from the active level to the non-active level. Thus, in pixel P in the n^{th} row (see FIG. 5), the reset transistor Te is turned off to finish resetting the potential of the photodiode PD. That is, the first reset unit 9 finishes resetting the potential of the photoelectric conversion unit 3, and the photoelectric conversion unit 3 starts charge storage operation.

At timings t9 to t12, similar operations are performed as at timings t5 to t8 respectively. Likewise, at timings t13 to t16, similar operations are performed as at timings t3 to t6 respectively.

At timing t17, the control unit 30 changes the control signal 4ADRESn from the non-active level to the active level. Thus, in pixel P in the n^{th} row (see FIG. 5), the select transistor Ta is turned on to put the pixel P in the selected state, and the amplifying transistor Tb, together with the load current source CS, performs source follower operation, thereby starting to output a signal according to the voltage of the charge-to-voltage converter 4 onto the signal line VLIN. That is, the selector 6 puts the pixel P in the selected state, and the amplifying unit 5 starts to output a signal based on the voltage of the charge-to-voltage converter 4 onto the signal line VLIN.

At timing t18, the control unit 30 changes the control signal φADRESn from the active level to the non-active level. Thus, in pixel P in the n^{th} row (see FIG. 5), the select transistor Ta is turned off to put the pixel P in the non-selected state to finish the signal output by the amplifying transistor Tb. That is, the selector 6 puts the pixel P in the non-selected state to finish the signal output by the amplifying unit 5.

At timing t19, similar operation is performed as at timing t1.

The period from timings t1 to t19 form a frame period FT1-n. During frame period FT1-n, in period TP0 from timings t1 to t2, the reset of the charge-to-voltage converter 4 is performed, which is performed prior to a plurality of times of the unit operation. In period TP1 from timings t2 to t4, the reset operation in the unit operation is performed. In period TP2 from timings t4 to t5, the charge storage operation in the unit operation is performed. In period TP3 from timings t5 to t6, the transfer operation in the unit operation is performed. That is, during the frame period FT1-n, in period TP0, the reset of the charge-to-voltage converter 4 is performed. In periods TP1 to TP3, the first-time unit operation is performed. Likewise, in periods TP4 to TP6, the second-time unit operation is performed. In periods TP8 to TP10, the sixth-time unit operation is performed. In period TP11, the output operation of the signals of the pixels P is performed.

The combined period of the periods TP0 and TP1 can be regarded as an initial setting period Tin1 for performing initial setting for the pixels P. The period TP2 is the first-time charge storage period Tex1. The combined period of the periods TP3 and TP4 is the first-time storage stop period Tcut1. The combined period of the charge storage period Tex1 and the storage stop period Tcut1 can be regarded as a first-time unit period Tun1.

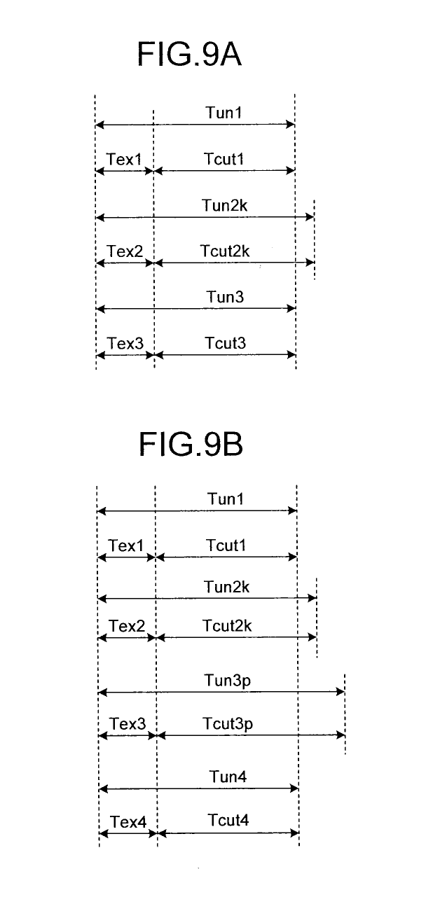

That is, in the frame period FT1-n, after the initial setting period Tin1 passes, the first-time unit period Tun1, second-time unit period Tun2, . . . , sixth-time unit period Tun6 follow one after another. In each unit period Tun1 to Tun6, the charge storage period Tex1 is shorter than the storage stop period Tcut1. Each unit period Tun1 to Tun6 has substantially the same time length. Further, as shown in FIG. 8A, in each unit period Tun1 to Tun6, charge storage periods Tex1 to Tex6 may have substantially the same time length as each other, and storage stop periods Tcut1 to Tcut6 may have substantially the same time length as each other. FIG. 8A is a diagram showing charge storage periods and storage stop periods.

As described above, in the embodiment, in the solid-state imaging device 1, the control unit 30 has each of the pixels P execute the unit operation a plurality of times during one frame period without outputting a signal based on the voltage of the charge-to-voltage converter 4 via the amplifying unit 5. The unit operation includes the reset operation, the charge storage operation, and the transfer operation. The reset operation is an operation of resetting the photoelectric conversion unit 3 in pixel P while keeping the transfer unit 8 in the non-active state. The charge storage operation is an operation of releasing the reset of the photoelectric conversion unit 3 in pixel P to have it store charges while keeping the transfer unit 8 in the non-active state. The transfer operation is an operation of transferring the charges in the photoelectric conversion unit 3 in pixel P to the charge-to-voltage converter 4 by keeping the transfer unit 8 in the active state. As such, during one frame period, charge transfer from the photoelectric conversion unit 3 to the charge-to-voltage converter 4 is performed intermittently over a longer time than the blinking cycle, so that an image of the lit-up state of an object such as a flickering display or traffic lights can be imaged with keeping appropriate exposure, without over-exposure. That is, an effective exposure amount (the number of photoelectrons) in the photoelectric conversion unit 3 can be made smaller than in the case of continuous exposure, and thus pixel saturation in the photoelectric conversion unit 3 can be suppressed, so that even with long-time exposure for the removal of flicker, imaging without over-exposure is possible.

Therefore, an image of the lit-up state of a blinking object can be obtained with a simple configuration (without a complex detecting system).

Further, in the embodiment, in the solid-state imaging device 1, the control unit 30, for each of the pixels P, resets the charge-to-voltage converter 4 and, after releasing the reset of the charge-to-voltage converter 4, has the pixel execute the unit operation a plurality of times during one frame period and, when finishing the plurality of times of the unit operation, output a signal based on the voltage of the charge-to-voltage converter 4 onto the signal line VLIN via the amplifying unit 5. Thus, respective charges obtained by a plurality of times of intermittent exposure during one frame period can be added in the pixel, and a signal according to the added charges can be outputted onto the signal line VLIN. As a result, where the length of one frame period is made considerably longer than the expected blinking cycle of the object, an image of the lit-up state of the blinking object can be easily obtained with keeping appropriate exposure.

Yet further, in the embodiment, in the solid-state imaging device 1, the control unit 30 controls for each of the pixels P so that the charge storage period, during which the charge storage operation is performed, becomes shorter than the storage stop period from the start of the transfer operation to the end of the reset operation. By this means, the charge storage period can be made to cover the period during which the object is lit up if the length of one frame period is made considerably longer than the expected blinking cycle of an object, and an image of the lit-up state of the blinking object can be easily obtained with keeping appropriate exposure.

Still further, in the embodiment, in the solid-state imaging device 1, the control unit 30 controls for each of the pixels P so that the total length of the charge storage period and the storage stop period in each unit operation of the plurality of times of the unit operation is constant. With this operations, the charge storage period can be easily made to cover the period during which the object is lit up if the length of one frame period is made considerably longer than the expected blinking cycle of an object.

It should be noted that, in the solid-state imaging device 1, the control unit 30 may control for each of the pixels P so that storage stop periods of different lengths occur during the plurality of times of the unit operation.

For example, as shown in FIG. 8B, while the unit periods Tun1 to Tun6 are maintained to have substantially the same time length as each other, the length of the storage stop period may be different for a particular unit period. FIG. 8B is a diagram showing charge storage periods and storage stop periods. In the case shown in FIG. 8B, the charge storage period Tex2i of the unit period Tun2i is longer than the charge storage period Tex1 of the unit period Tun1. Accordingly the storage stop period Tcut2i of the unit period Tun2i is shorter than the storage stop period Tcut1 of the unit period Tun1. The length of the charge storage period Tex3 of the unit period Tun3 is back to substantially the same as that of the charge storage period Tex1 of the unit period Tun1. For example, these patterns of the unit period Tun1 and of the unit period Tun2i may alternate during one frame period.

Or, for example, as shown in FIG. 8C, while the unit periods Tun1 to Tun6 are maintained to have substantially the same time length as each other, the length of the storage stop period may be different stepwise for particular unit periods. FIG. 8C is a diagram showing charge storage periods and storage stop periods. In the case shown in FIG. 8C, the charge storage period Tex2i of the unit period Tun2i is longer than the charge storage period Tex1 of the unit period Tun1. Accordingly the storage stop period Tcut2i of the unit period Tun2i is shorter than the storage stop period Tcut1 of the unit period Tun1. The charge storage period Tex3j of the unit period Tun3j is longer than the charge storage period Tex2i of the unit period Tun2i. Accordingly the storage stop period Tcut3j of the unit period Tun3j is shorter than the storage stop period Tcut2i of the unit period Tun2i. The length of the charge storage period Tex4 of the unit period Tun4 is back to substantially the same as that of the charge storage period Tex1 of the unit period Tun1. For example, these patterns of the unit period Tun1, of the unit period Tun2i, and of the unit period Tun3j may be repeated periodically during one frame period.

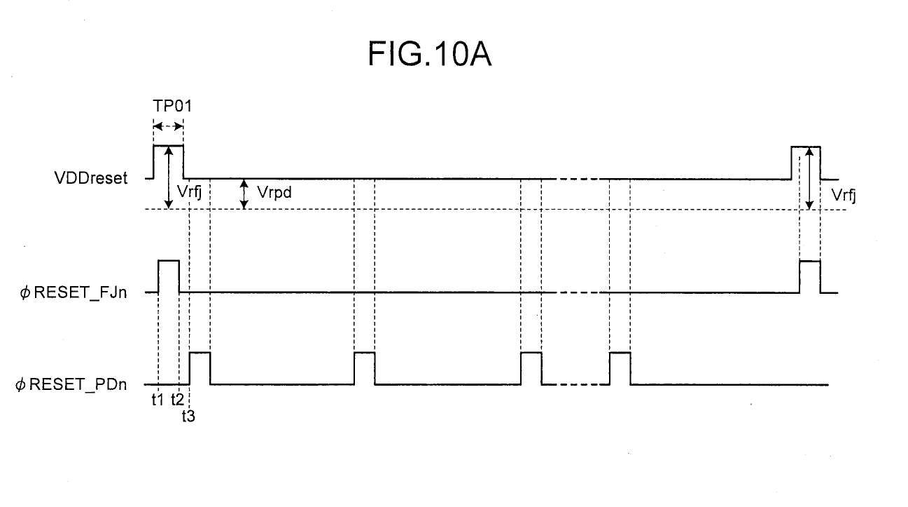

Or, for example, as shown in FIG. 9A, while the charge storage periods Tex1 to Tex6 are maintained to have substantially the same time length as each other, the length of the unit period may be different for a particular unit period. FIG. 9A is a diagram showing charge storage periods and storage stop periods. In the case shown in FIG. 9A, the unit period Tun2k is longer than the unit period Tun1. Accordingly the storage stop period Tcut2k of the unit period Tun2k is longer than the storage stop period Tcut1 of the unit period Tun1. The length of the unit period Tun3 is back to substantially the same as that of the unit period Tun1. For example, these patterns of the unit period Tun1 and of the unit period Tun2k may alternate during one frame period.

Or, for example, as shown in FIG. 9B, while the charge storage periods Tex1 to Tex6 are maintained to have substantially the same time length as each other, the length of the unit period may be different stepwise for particular unit periods. FIG. 9B is a diagram showing charge storage periods and storage stop periods. In the case shown in FIG. 9B, the unit period Tun2k is longer than the unit period Tun1. Accordingly the storage stop period Tcut2k of the unit period Tun2k is longer than the storage stop period Tcut1 of the unit period Tun1. The unit period Tun3p is longer than the unit period Tun2k. Accordingly the storage stop period Tcut3p of the unit period Tun3p is longer than the storage stop period Tcut2k of the unit period Tun2k. The length of the unit period Tun4 is back to substantially the same as that of the unit period Tun1. For example, these patterns of the unit period Tun1, of the unit period Tun2k, and of the unit period Tun3p may be repeated periodically during one frame period.

Or, for example, in the solid-state imaging device 1, the control unit 30 may further reset the photoelectric conversion unit 3 in period TP0 shown in FIG. 7. For example, the control unit 30, at timing t1, changes the control signals φRESET_FJn, φREADn from the non-active level to the active level. Thus, the transfer transistor Td and the reset transistor Tc are turned on, so that the reset transistor Tc resets the potential of the floating junction FJ and the potential of the photodiode PD simultaneously. Then the control unit 30, at timing t2, changes the control signals φRESET_FJn, φREADn from the active level to the non-active level. Thus, the reset transistor Tc finishes resetting the potential of the floating junction FJ and the potential of the photodiode PD simultaneously. In this case, because period TP1 in the waveform chart of FIG. 7 can be omitted, the length of one frame period can be shortened accordingly. At this time, the potential VDDreset of the reset power supply may be common to the pixel rows.

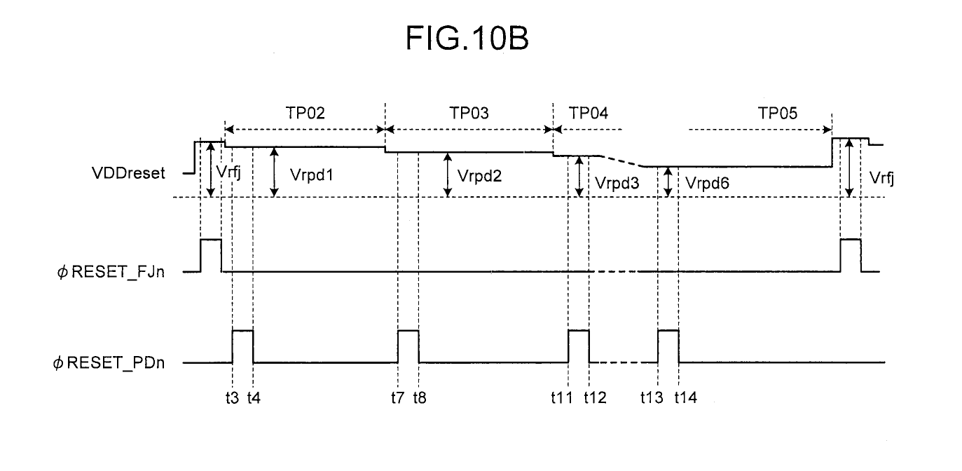

Or in the solid-state imaging device 1, the control unit 30 may change the potential of the reset power supply for each pixel row as shown in FIGS. 10A, 10B. FIGS. 10A, 10B are waveform charts showing the operation of pixel P. FIGS. 10A, 10B show illustratively the operation of pixel P in the nth row and also apply to the pixels in the other rows.

For example, in the case shown in FIG. 10A, the control unit 30 keeps the potential VDDresetn of the reset power supply at potential Vrfj during period TP01 including the period from timings t1 to t2 during which it keeps the control signal φRESET_FJn at the active level. After period TP01 ends (e.g., immediately before timing t3), the control unit 30 sets the potential VDDresetn of the reset power supply at potential Vrpd lower than potential Vrfj. The potential Vrfj is a potential for the reset of the floating junction FJ and is set higher than the potential Vrpd for the reset of the photodiode PD. Thus, in a plurality of times of charge transfer from the photodiode PD to the floating junction FJ, backward charge flow from the floating junction FJ to the photodiode PD can be reliably suppressed.

Or, for example, in the case shown in FIG. 10B, the control unit 30 keeps the potential VDDresetn of the reset power supply at potential Vrfj during period TP01 including the period from timings t1 to t2 during which it keeps the control signal φRESET_FJn at the active level. The control unit 30 keeps the potential VDDresetn of the reset power supply at potential Vrpd1 lower than potential Vrfj during period TP02 including the period from timings t3 to t4 during which it keeps the control signal φRESET_PDn at the active level. The control unit 30 keeps the potential VDDresetn of the reset power supply at potential Vrpd2 lower than potential Vrpd1 during period TP03 including the period from timings t7 to t8 during which it keeps the control signal φRESET_PDn at the active level. The control unit 30 keeps the potential VDDresetn of the reset power supply at potential Vrpd3 lower than potential Vrpd2 during period TP04 including the period from timings t11 to t12 during which it keeps the control signal φRESET_PDn at the active level. The control unit 30 keeps the potential VDDresetn of the reset power supply at potential Vrpd6 lower than potential Vrpd3 during period TP05 including the period from timings t13 to t14 during which it keeps the control signal φRESET_PDn at the active level. The potential Vrfj is a potential level for the reset of the floating junction FJ and is set higher than the levels Vrpd1 to Vrpd6 for the reset of the photodiode PD. Thus, in a plurality of times of charge transfer from the photodiode PD to the floating junction FJ, backward charge flow from the floating junction FJ to the photodiode PD can be reliably suppressed. Further, because the level of the potential VDDresetn of the reset power supply is decreased stepwise in the order of Vrfj, Vrpd1, Vrpd2, Vrpd3, . . . , and Vrpd6, the oscillation (hunting) of the potential VDDresetn of the reset power supply can be suppressed while backward charge flow from the floating junction FJ to the photodiode PD is reliably suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a plurality of pixels arranged; and
a control unit that controls the plurality of pixels,
wherein each of the plurality of pixels has:
a photoelectric conversion unit;
a charge-to-voltage converter;
a transfer unit that, when in an active state, transfers charges in the photoelectric conversion unit to the charge-to-voltage converter and, when in a non-active state, does not transfer charges in the photoelectric conversion unit to the charge-to-voltage converter; and
an amplifying unit that outputs a signal based on the voltage of the charge-to-voltage converter, and
wherein the control unit has each of the plurality of pixels execute a unit operation a plurality of times during a frame period without outputting the signal based on the voltage of the charge-to-voltage converter via the amplifying unit, the unit operation including a reset operation, a charge storage operation, and a transfer operation, the reset operation resetting the photoelectric conversion unit while keeping the transfer unit in the non-active state, the charge storage operation releasing the reset of the photoelectric conversion unit to have the photoelectric conversion unit store charges while keeping the transfer unit in the non-active state, the transfer operation transferring charge in the photoelectric conversion unit to the charge-to-voltage converter by keeping the transfer unit in the active state.

2. The solid-state imaging device according to claim 1, wherein
the control unit, for each of the plurality of pixels, resets the charge-to-voltage converter and, after releasing the reset of the charge-to-voltage converter, has the pixel execute the unit operation a plurality of times during a frame period and, when finishing the plurality of times of the unit operation, output the signal based on the voltage of the charge-to-voltage converter via the amplifying unit.

3. The solid-state imaging device according to claim 2, wherein
each of the plurality of pixels further has:
a first reset unit that resets the photoelectric conversion unit; and
a second reset unit that resets the charge-to-voltage converter.

4. The solid-state imaging device according to claim 2, wherein
the frame period is a period from a timing when the reset of the charge-to-voltage converter in each of the plurality of pixels is started to a timing when the reset of the charge-to-voltage converter is started next time.

5. The solid-state imaging device according to claim 2, wherein
the control unit, for each of the plurality of pixels, resets the photoelectric conversion unit during a first period starting from finish timing of the reset of the charge-to-voltage converter while keeping the transfer unit in the non-active state, releases the reset of the photoelectric conversion unit to have the photoelectric conversion unit store charges during a second period subsequent to the first period while keeping the transfer unit in the non-active state, and transfers charges in the photoelectric conversion unit to the charge-to-voltage converter by putting the transfer unit in the active state during a third period subsequent to the second period.

6. The solid-state imaging device according to claim 5, wherein
the control unit resets the charge-to-voltage converter during a period immediately before the first period while keeping the transfer unit in the non-active state.

7. The solid-state imaging device according to claim 6, wherein
the control unit resets the charge-to-voltage converter to a first potential during a period immediately before the first period and resets the photoelectric conversion unit to a second potential lower than the first potential during the first period.

8. The solid-state imaging device according to claim 5, wherein
the control unit resets the charge-to-voltage converter during the first period while keeping the transfer unit in the non-active state.

9. The solid-state imaging device according to claim 5, wherein
the control unit resets the photoelectric conversion unit during a fourth period subsequent to the third period while keeping the transfer unit in the non-active state, releases the reset of the photoelectric conversion unit to have the photoelectric conversion unit store charges during a fifth period subsequent to the fourth period while keeping the transfer unit in the non-active state, and transfers charges in the photoelectric conversion unit to the charge-to-voltage converter by putting the transfer unit in the active state during a sixth period subsequent to the fifth period.

10. The solid-state imaging device according to claim 9, wherein
the control unit resets the charge-to-voltage converter to a first potential during a period immediately before the first period, resets the photoelectric conversion unit to a second potential lower than the first potential during the first period, and resets the photoelectric conversion unit to a third potential lower than the second potential during the fourth period.

11. The solid-state imaging device according to claim 9, wherein
the control unit puts the pixel in a selected state to output the signal based on the voltage of the charge-to-voltage converter via the amplifying unit during a period starting from the finish timing of the plurality of times of the unit operation.

12. The solid-state imaging device according to claim 1, wherein
the control unit controls for each of the plurality of pixels so that a charge storage period during which the charge storage operation is performed is shorter than a storage stop period from the start of the transfer operation to the end of the reset operation.

13. The solid-state imaging device according to claim 12, wherein
the control unit controls for each of the plurality of pixels so that the total length of the charge storage period and the storage stop period is substantially the same for each unit operation of the plurality of times of the unit operation.

14. The solid-state imaging device according to claim 13, wherein
the control unit controls for each of the plurality of pixels so that a plurality of the storage stop periods having a different length occur during the plurality of times of the unit operation.

15. The solid-state imaging device according to claim 14, wherein
the control unit controls so that the plurality of the storage stop periods having a different length occur periodically.

16. The solid-state imaging device according to claim 15, wherein
the control unit controls for each of the plurality of pixels so that a first charge storage period, a first storage stop period, a second charge storage period longer than the first charge storage period, and a second storage stop period shorter than the first storage stop period sequentially occur during the plurality of times of the unit operation.

17. The solid-state imaging device according to claim 12, wherein
the control unit controls for each of the plurality of pixels so that the charge storage period is substantially the same in length for each unit operation of the plurality of times of the unit operation.

18. The solid-state imaging device according to claim 17, wherein
the control unit controls for each of the plurality of pixels so that a plurality of the storage stop periods having a different length occur during the plurality of times of the unit operation.

19. The solid-state imaging device according to claim 18, wherein
the control unit controls so that the plurality of the storage stop periods having a different length occur periodically.

20. The solid-state imaging device according to claim 19, wherein
the control unit controls for each of the plurality of pixels so that a first charge storage period, a first storage stop period, a second charge storage period having substantially the same time length as the first charge storage period, and a second storage stop period having a different time length from the first storage stop period sequentially occur during the plurality of times of the unit operation.
